(19) United States
(12) Patent Application Publication
(10) Pub. No.: US 2024/0330279 A1
(43) Pub. Date: Oct. 3, 2024

(54) TECHNIQUES FOR GENERATING AND CORRECTING DATABASE QUERIES USING LANGUAGE MODELS

(71) Applicant: VIANAI SYSTEMS, INC., Palo Alto, CA (US)

(72) Inventors: Tu TRUONG, San Jose, CA (US); Maxwell K. BERGSTEIN, New York, NY (US); Walid RAHMAN, New York, NY (US); Alex WILSON, Kenilworth, IL (US)

(21) Appl. No.: 18/621,619

(22) Filed: Mar. 29, 2024

Related U.S. Application Data
(60) Provisional application No. 63/493,693, filed on Mar. 31, 2023.

(51) Int. Cl. G06F 16/242

(52) U.S. Cl. CPC G06F 16/2428

(57) ABSTRACT

One embodiment of a method for generating a query includes receiving a user input, selecting, from a plurality of predefined inputs, at least one predefined input based on similarity to the user input, and prompting a trained machine learning model to generate a query based on the user input and at least one predefined query associated with the least one predefined input.

### CROSS-REFERENCE TO RELATED APPLICATIONS

This application claims priority benefit of the United States Provisional Patent Application titled, “TECHNIQUES FOR GENERATING AND CORRECTING LANGUAGE MODEL OUTPUTS,” filed on Mar. 31, 2023, and having Ser. No. 63/493,693. The subject matter of this related application is hereby incorporated herein by reference.

### BACKGROUND

### Field of the Various Embodiments

The embodiments of the present disclosure relate generally to the fields of computer science, machine learning, and artificial intelligence, and more specifically, to techniques for generating and correcting database queries using language models.

### Description of the Related Art

Language models have become increasingly capable of performing various natural language processing tasks. Large language models (LLMs) are one type of language model. Conventionally, an LLM is implemented as a neural network that includes a large number (e.g., billions) of parameters and is trained on a large quantity of text data.

Once trained, an LLM is oftentimes able to perform a wide variety of natural language processing tasks. One natural language processing task that a trained LLM can perform is query generation. Query generation is the process of automatically creating a query given an input, such as natural language text. The goal of query generation is to bridge the gap between user intent, as expressed in the input, and the retrieval of information. For example, an LLM can be prompted to generate a structured query language (SQL) query for searching a database and generating an answer to a natural language user question.

One drawback of conventional language models, and conventional LLMs in particular, is that these models sometimes generate incorrect queries that cannot be successfully executed against databases. In that regard, natural language requests from a user can be ambiguous and complex, so a language model can have difficulty capturing and translating the user intent from a user request into a query. In some cases, the language model may also not understand details of the database being queried, such as table names, column names, relationships between tables, and data types in the database, as well as various functions, clauses, and permitted structures of queries.

As the foregoing illustrates, what is needed in the art are more effective techniques for generating database queries using language models.

### SUMMARY

One embodiment of the present disclosure sets forth a computer-implemented method for generating a query. The method includes receiving a user input. The method further includes selecting, from a plurality of predefined inputs, at least one predefined input based on similarity to the user input. In addition, the method includes prompting a first trained machine learning model to generate a query based on the user input and at least one predefined query associated with the least one predefined input.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is, with the disclosed techniques, the automatically generated queries can be generated that executed successfully. The disclosed technique can generate more accurate database queries that capture the user intent in user requests by learning from example queries associated with example requests that are most similar to the user requests. The generated queries can also be optimized to utilize computational resources efficiently by learning from relatively efficient example queries. In addition, the disclosed techniques can regenerate automatically generated queries to correct execution errors. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments;

FIG. 2 is a more detailed illustration of the natural language application of FIG. 1, according to various embodiments;

FIG. 3 is a flow diagram of method steps for generating and using example requests and associated queries, according to various embodiments; and

FIG. 4 is a flow diagram of method steps for responding to a user request, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

### System Overview

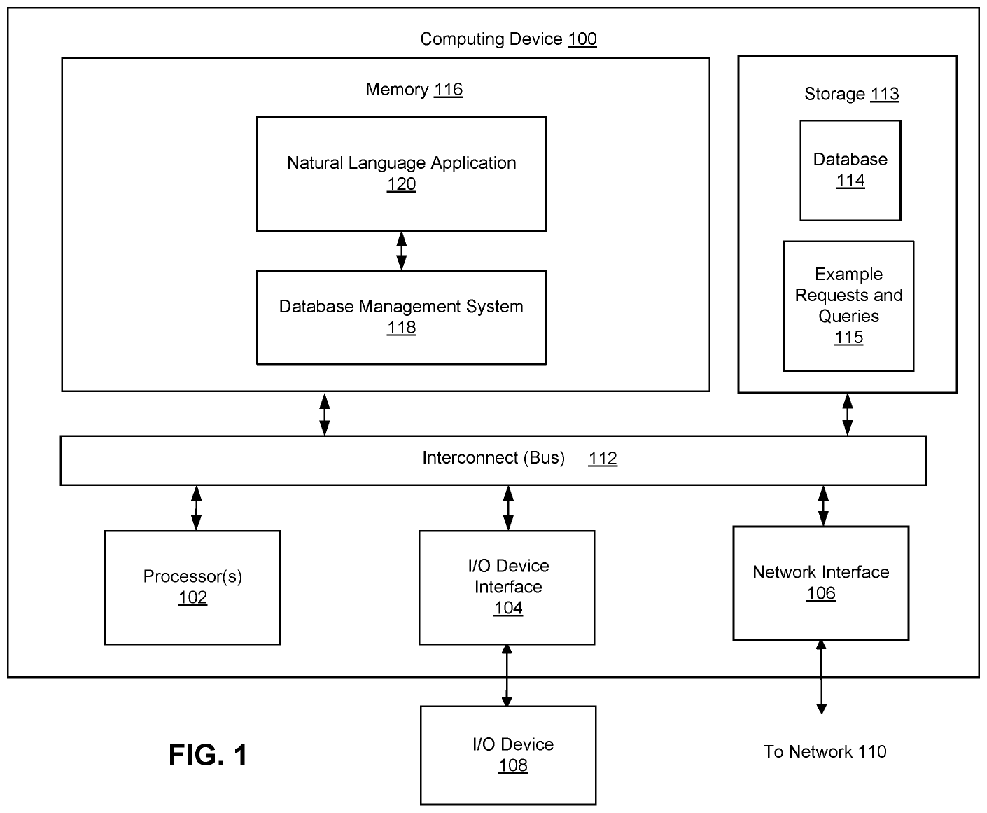

FIG. 1 illustrates a computing device 100 configured to implement one or more aspects of various embodiments. In some embodiments, the computing device 100 can be a desktop computer, a laptop computer, a smart phone, a personal digital assistant (PDA), tablet computer, server machine, or any other type of computing device configured to receive input, process data, and optionally display images, and is suitable for practicing one or more embodiments of the present disclosure. As shown, computing device 100 is configured to run a natural language application 120 and a database management system 118 that reside in a memory 116.

It is noted that computing device 100 described herein is illustrative and that any other technically feasible configurations fall within the scope of the present disclosure. For example, multiple instances of natural language application 120 and/or database management system 118 could execute on a set of nodes in a data center, cluster, or cloud computing environment to implement the functionality of computing device 100. In another example, natural language application 120 and/or database management system 118 could be implemented using any number of hardware and/or software components or layers.

As shown, computing device 100 includes, without limitation, an interconnect (bus) 112 that connects one or more processors 102, an input/output (I/O) device interface 104 coupled to one or more input/output (I/O) devices 108, memory 116, a storage 113 that stores a database 114, and a network interface 106. Processor(s) 102 may be any suitable processor(s) implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, processor(s) 102 can be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In some embodiments, I/O devices 108 include devices capable of receiving input, such as a keyboard, a mouse, a touchpad, and/or a microphone, as well as devices capable of providing output, such as a display device and/or speaker. Additionally, I/O devices 108 can include devices capable of both receiving input and providing output, such as a touchscreen, a universal serial bus (USB) port, and so forth. The I/O devices 108 can be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In some embodiments, network 110 is any technically feasible type of communications network that allows data to be exchanged between computing device 100 and external entities or devices, such as a web server or another networked computing device. For example, network 110 could include a wide area network (WAN), a local area network (LAN), a wireless (WiFi) network, and/or the Internet, among others.

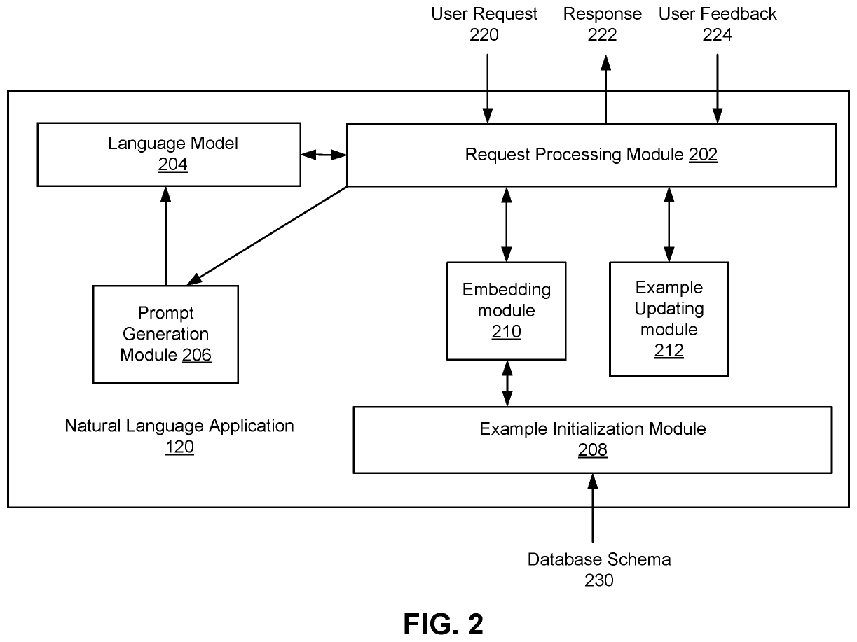

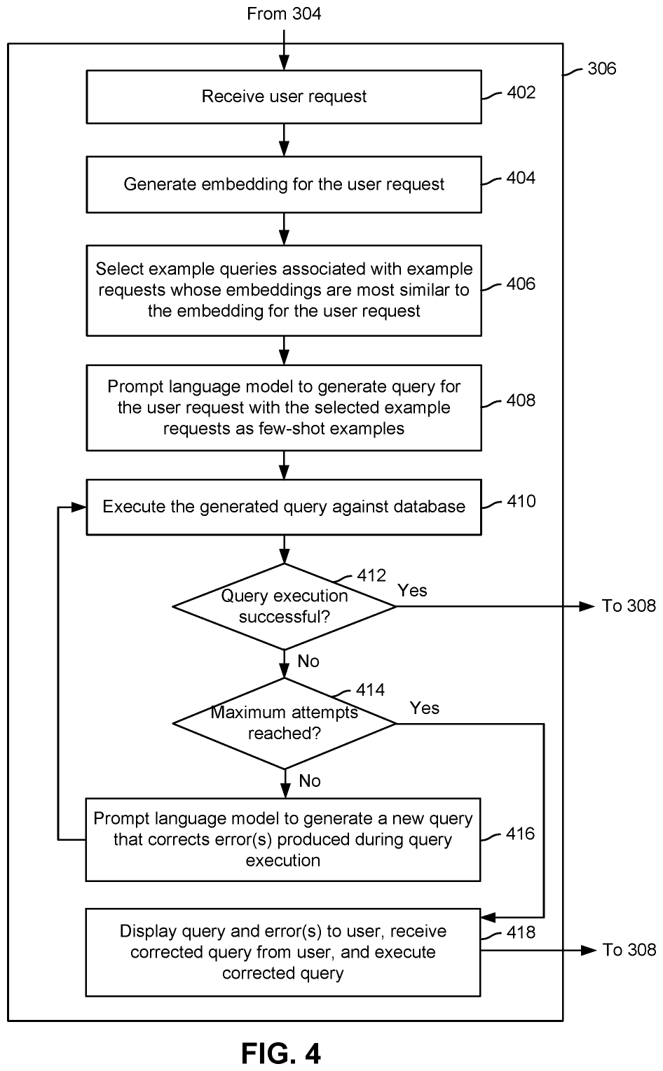

In some embodiments, storage 113 is a non-volatile storage for applications and data, and may include fixed or removable disk drives, flash memory devices, and CD-ROM, DVD-ROM, Blu-Ray, HD-DVD, or other magnetic, optical, or solid-state storage devices. Illustratively, storage 113 stores, without limitation, a database 114 and example requests and queries 115. Example requests and queries 115 provides a set of example requests and example queries for a specific database schema, as discussed in greater detail below in conjunction with FIGS. 2 and 4. Although shown as distinct from database 114, in some embodiments, example requests and queries 115 and/or embeddings thereof can be stored in database 114. In addition, natural language application 120 and database management system 118 can be stored in storage 113 and loaded into memory 116 when executed.

In some embodiments, memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 can store various software programs, including natural language application 120 and database management system 118, that can be executed by the processor(s) 102 and application data associated with such software programs.

Database management system 118 is configured to store, retrieve, define, and manage data in database 114. In some embodiments, database management system 118 serves as an interface between database 114 and application programs, such as natural language application 120. In some embodiments, natural language application 120 is configured to generate and correct database queries for a user request using a language model and example queries associated with similar example queries from the example requests and queries 115, as discussed in greater detail below in conjunction with FIGS. 2-4. In such cases, natural language application 120 can also display the generated query to a user and receive feedback that can be used to add (or not add) the user request and the generated query as examples in the example requests and queries 115.

### Generating Database Queries

FIG. 2 is a more detailed illustration of the natural language application 120 of FIG. 1, according to various embodiments. As shown, natural language application 120 includes, without limitation, a request processing module 202, a language model 204, a prompt generation module 206, an example initialization module 208, an embedding module 210, and an example updating module 212. In operation, natural language application 120 receives a user request 220 as input and outputs a response 222 that is generated by prompting language model 204 to generate a query for the user 220 and executing the query against database 114. Although described herein primarily with respect to requests, responses, and language model 204 as a reference example, in some embodiments, the techniques disclosed herein can be applied to any suitable inputs and outputs, and any technically feasible machine learning models can be used.

Given user request 220 as input, request processing module 202 searches for example requests that are similar to user request 220 in example requests and queries 115. In some embodiments, request processing module 202 instructs embedding module 212 to generate an embedding of user request 220, and request processing module 202 searches for the similar example requests by comparing the embedding of user request 220 with embeddings of example requests, which can be stored along with example requests and queries 115. In such cases, embedding module 210 generates a compressed representation of text from user request 220 that maps words, phrases, and the entire text to the embedding, which can be a vector of numbers. The embedding that is output by embedding module 210 can capture semantic properties of user request 220. Using the embedding for user request 220 and previously generated embeddings of example requests in example requests and queries 115, request processing module 202 can apply an embedding search for user request 220 to identify the top N most similar example requests from the example requests and queries 115. Any technically feasible similarity metric can be used to identify the top N most similar example requests. For example, in some embodiments, the similarity metric can be Cosine similarity, and the most similar example requests can be associated with similarity values that are higher than a predefined threshold. Although described herein with respect to N most similar example requests, it should be noted that fewer than N example requests can be used if less than N example requests are within the similarity threshold. In some embodiments, if no embeddings of example requests are within a similarity threshold to the embedding of user request, then request processing module 202 does not process the request under the assumption that any query generated by language model 204 will not be good.

In some embodiments, request processing module 202 generates a query for user request 220 with the guidance of the most similar queries retrieved from the example requests and queries 115. More specifically, request processing module 202 can use language model 204 to generate the query. Language model 204 is a machine learning model trained to perform one or more natural language processing tasks, such as query generation, question answering and/or summarization. Any technically feasible language model 204 can be used in some embodiments, such as GPT (Generative Pre-trained Transformer), BERT (Bidirectional Encoder Representations from Transformers), Transformer, or the like. In some embodiments, language model 204 can be a large language model (LLM). Although language model 204 is shown as being included in natural language application 120, in some embodiments language model 204 can be external to natural language application 120. For example, in some embodiments, language model 204 can be executed in a cloud computing environment and accessible to natural language application 120 via an application programming interface (API). Although one language model 204 is shown for simplicity, in some embodiments, multiple language models can be used, such as different language models that are fine tuned for different tasks. For example, one or more of the prompts described herein can be used to prompt different language models. To generate a query for user request 220, request processing module 202 causes prompt generation module 206 to generate a prompt that includes user request 220 and the most similar queries as few-shot prompt examples. In the context of language models, prompts are used to guide the language model to generate responses and/or complete tasks. In some embodiments, prompt generation module 206 can, without limitation, generate a prompt that specifies a task to be performed, provides necessary context or background information, and/or controls the format and structure of output by language model 204. Prompt generation module 206 communicates with request processing module 202 to receive the task and context required to generate the prompt and inputs the generated prompt into language model 204 or returns the prompt to request processing module 202 for input into language model 204. After receiving the prompt as input, language model 204 outputs the query for user request 220. Language model 204 is able to generate the query because language model 204 was trained on training data that included example queries, and the most similar queries further provide few-shot prompt examples of the query to generate. In some embodiments, request processing module 202 can also attempt to execute the generated queries and (optionally) progressively modify the queries when execution of the queries produces error(s) by prompting language 204 model to generate new query (ies) that correct the error(s).

In some embodiments, request processing module 202 also displays the generated query to a user via a user interface and receives feedback on the generated query and/or response 222 from the user. When the user feedback is positive or if the user corrects the generated query, request processing module 202 can add the user request 220 and the generated (or corrected) query to the example requests and queries 115.

In addition or alternatively, in some embodiments, request processing module 202 is configured to identify key terms in user request 220 and ask prompt generation module 206 to generate a prompt that includes specific instructions on which columns of tables in database 114 and/or which formulas language model 204 should use when generating a query. In such cases, request processing module 202 can use a map (not shown) that encodes industry/domain knowledge to determine the specific instructions on which columns of tables in the database 114 and/or which formulas the language model 204 should use. In some embodiments, the map includes mappings between key terms and definitions that each specify column(s) of tables in database 114 and/or operation(s) in a programming language. For example, a definition could specify column(s) of tables that correspond to a particular key term. As another example, a definition could specify a particular formula, such as arithmetic operations over multiple columns or rows translated into a function in the programming language that creates a new column, in the generated query. Given user request 220, request processing module 202 identifies predefined key terms in user request 220, maps each key term to a definition using the map, and instructs prompt generation module 206 to generate a prompt that includes the definition. In some embodiments, request processing module 202 can identify the predefined key terms using exact matching, fuzzy matching, key word matching, and/or semantic matching (e.g., matching of vectorized embeddings) techniques. In some embodiments, the prompt also includes the most similar example queries and is generated via the techniques described above.

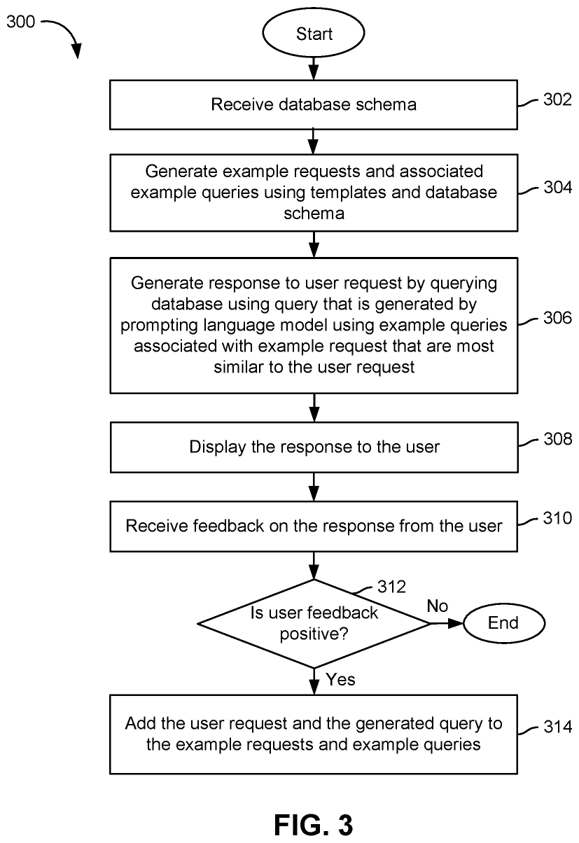

FIG. 3 is a flow diagram of method steps for generating and using example requests and associated queries, according to various embodiments. Although the method steps are described in conjunction with FIG. 1-2, persons skilled in the art will understand that any system configured to perform the method steps, in any order, falls within the scope of the present disclosure.

As shown, a method 300 begins at step 302, where natural language application 120 receives database schema 230. In some embodiments, database schema 230 can specify database tables, column names, data types for each field, and/or relationships between different portions of data stored in database 114.

At step 304, example initialization module 208 of natural language application 120 generates example requests and associated example queries using predefined templates and the database schema 230 received at step 302. In some embodiments, the templates can be associated with frequently made requests (e.g., frequently asked questions) and/or requests that users may make. Using database schema 230 and the templates, example requests and queries 115 can be generated that are specific to database 114. In addition, embedding module 210 can generate embeddings of example requests and store the embeddings along with example requests and queries 115, in database 114, or elsewhere.

At step 306, request processing module 202 generates a response (e.g.,

response 222) to a user request (e.g., user request 220) by querying database 114 using a query that is generated by prompting language model 204 using example queries associated with example requests that are most similar to the user request. Step 306 is discussed in greater detail below in conjunction with FIG. 4.

At step 308, natural language application 120 causes the generated response to be displayed to the user. In some embodiments, the generated response can be displayed in any technically feasible manner, such as via a user interface (UI). In some embodiments, the natural language application 120 can also process the query result in any suitable manner to generate the response before displaying the result to the user.

At step 310, natural language application 120 receives user feedback 224 on the response 222 from the user. Any suitable user feedback 224 can be received in some embodiments. For example, in some embodiments, the user can select to approve or disapprove the response 222 via the user interface that displays response 222. As another example, in some embodiments, the generated query can also be displayed to the user, who can verify and/or make corrections to the query. Further, user feedback 224 can be received in any technically feasible manner, such as via the same user interface used to display the response.

At step 312, natural language application 120 determines if user feedback 224 is positive. For example, in some embodiments, the feedback can be positive when the user approves the response 222. As another example, in some embodiments, the feedback can be positive when the user verifies or corrects a generated query.

If natural language application 120 determines that user feedback 224 is not positive, then method 300 end. On the other hand, if natural language application 120 determines that user feedback 224 is positive, then method 300 continues to step 314, where example updating module 212 of natural language application 120 adds the user request 220 and the generated query to the example requests and queries 115.

FIG. 4 is a flow diagram of method steps for responding to a user request, according to various embodiments. Although the method steps are described in conjunction with FIG. 1-2, persons skilled in the art will understand that any system configured to perform the method steps, in any order, falls within the scope of the present disclosure.

As shown, at step 402, natural language application 120 receives user request 220. Any suitable user request that includes text, such as a question from the user, can be received in some embodiments.

At step 404, request processing module 202 causes embedding module 210 to generate an embedding for user request 220. The embedding can be used to search for the most similar example requests and associated example queries in example requests and queries 115.

At step 406, request processing module 202 selects example queries associated with example requests whose embeddings are most similar to the embedding for the user request 220. In some embodiments, request processing module 202 performs an embedding search with a similarity metric, such as Cosine similarity, to find, in the example requests and queries 115, N most similar requests whose embeddings are closest in distance the embedding for user request 220, and queries associated with the most similar requests. In some embodiments, if no example requests are within a threshold of similarity to the user request, then method 300 can end under the assumption that any query generated by language model 204 will not be good.

At step 408, request processing module 202 causes language model 204 to generate a query for the user request with the selected example queries as few-shot prompt examples. In some embodiments, request processing module 202 instructs prompt generation module 206 to generate a prompt that includes user request 220 and the N example queries associated with the most similar requests that were selected at step 406. In such cases, prompt generation module 206 or request processing module 202 can input the prompt into language model 204 that outputs a query for the user request. In addition or alternatively, in some embodiments, request processing module 202 can identify key terms in user request 220 and ask prompt generation module 206 to include in the prompt specific instructions on which columns of tables in database 114 and/or which formulas language model 204 should use when generating the query.

At step 410, request processing module 202 causes the generated query to be executed against database 114. In some embodiments, request processing module 202 can cause database management system 118 to execute the query. The execution results can be (or be used to generate) response 222, or the execution can fail and generate error(s).

At step 412, if the query execution was successful, then method 300 continues to step 308, where request processing module 202 causes a result from executing the query to be displayed to the user. In some embodiments, steps 412-418 are optional, and request processing module 202 displays no result (e.g., a message stating that there is no data), that the query cannot be executed, or the like if the query execution is not successful.

On the other hand, if the query execution was not successful, then method 300 continues to step 414, where request processing module 202 determines if a maximum number of attempts have been reached. If the maximum number of attempts have not been reached, then method 300 continues to step 416, where request processing module 202 prompts language model 204 to generate a new query that corrects error(s) produced during execution of the query by database management system 118. In some embodiments, request processing module 202 causes prompt generation module 206 to generate a prompt that includes the user request 220, the previously generated query, and the error message from database management system 118. In such cases, request processing module 202 inputs the generated prompt into language model 204, which generates a new query using the information in the error message. Method 300 then returns to step 410, where request processing module 202 causes the new query to be executed against database 114.

On the other hand, if request processing module 202 determines at step 414 that the maximum number of attempts has been reached, then method 300 continues to step 418, where request processing module 202 displays the generated query and the execution error(s) to a user, receives a corrected query from the user, and executes the corrected query against database 114. In some embodiments, request processing module 202 can instead display no result (e.g., a message stating that there is no data), display that the query cannot be executed, or the like if the query execution is not successful after the maximum number of attempts. Method 300 then continues to step 308, where request processing module 202 causes a response generated from executing the query to be displayed to the user.

In sum, techniques are disclosed for generating database queries in response to user requests using language models. In some embodiments, during initialization, a natural language application generates example requests and associated example queries using templates and a database schema. Subsequently, when a user request is received, the natural language application generates an embedding of the user request and performs an embedding search to identify example requests that are most similar to the user request. The natural language application generates a prompt that includes the user request and example queries associated with the most similar example requests as few-shot prompt examples. Using the generated prompt, the natural language application prompts the language model to generate a query for the user request, learning from the example queries provided in the prompt. If execution of the query produces error(s), the natural language application repeatedly prompts the language model to generate another query that corrects the error(s), until a query is generated that can execute successfully or a maximum number of attempts is reached. When the maximum number of attempts is reached, a user can be permitted to correct the generated query via a user interface, do result can be displayed, or the like. Successfully executed queries and associated requests can also be added to the example requests and queries in order to be used for future embedding searches.

One technical advantage of the disclosed techniques relative to the prior art is, with the disclosed techniques, the automatically generated queries can be generated that executed successfully. The disclosed technique can generate more accurate database queries that capture the user intent in user requests by learning from example queries associated with example requests that are most similar to the user requests. The generated queries can also be optimized to utilize computational resources efficiently by learning from relatively efficient example queries. In addition, the disclosed techniques can regenerate automatically generated queries to correct execution errors. These technical advantages provide one or more technological improvements over prior art approaches.
1. In some embodiments, a computer-implemented method for generating a query comprises receiving a user input, selecting, from a plurality of predefined inputs, at least one predefined input based on similarity to the user input, and prompting a first trained machine learning model to generate a query based on the user input and at least one predefined query associated with the least one predefined input.
2. The computer-implemented method of clause 1, wherein selecting the at least one predefined input comprises generating an embedding of the user input, computing a plurality of distances between the embedding of the user input and a plurality of embeddings of the plurality of predefined inputs, and selecting the at least one predefined input based on the plurality of distances and a distance threshold.
3. The computer-implemented method of clauses 1 or 2, further comprising generating the plurality of predefined inputs based on one or more database fields and one or more first predefined templates, and generating a plurality of predefined queries associated with the plurality of predefined inputs based on the one or more database fields and one or more second predefined templates.
4. The computer-implemented method of any of clauses 1-3, wherein the plurality of predefined inputs are further generated based on one or more user inputs.
5. The computer-implemented method of any of clauses 1-4, further comprising displaying the query to a user, receiving, from the user, a corrected query that corrects the query, and storing the user input as a new predefined input and the corrected query as a new predefined query.
6. The computer-implemented method of any of clauses 1-5, further comprising determining one or more key terms included in the user input, wherein the first trained machine learning model is further prompted to generate the query based on at least one of a database field or a formula associated with the one or more key terms.
7. The computer-implemented method of any of clauses 1-6, wherein prompting the first trained machine learning model to generate the query comprises inputting, into the first trained machine learning model, a prompt that includes the user input and the at least one predefined query as at least one example.
8. The computer-implemented method of any of clauses 1-7, further comprising executing the query using a database system, and in response to receiving an error from the database system, prompting a second trained machine learning model to generate a corrected query based on the user input, the query, and the error.
9. The computer-implemented method of any of clauses 1-8, wherein the first trained machine learning model is the second trained machine learning model.
10. The computer-implemented method of any of clauses 1-9, wherein the first trained machine learning model comprises a large language model (LLM).
11. In some embodiments, one or more non-transitory computer readable media include instructions that, when executed by one or more processors, cause the one or more processors to perform the steps of receiving a user input, selecting, from a plurality of predefined inputs, at least one predefined input based on similarity to the user input, and prompting a first trained machine learning model to generate a query based on the user input and at least one predefined query associated with the least one predefined input.
12. The one or more non-transitory computer readable media of clause 11, wherein selecting the at least one predefined input comprises generating an embedding of the user input using a second trained machine learning model, computing a plurality of distances between the embedding of the user input and a plurality of embeddings of the plurality of predefined inputs, and selecting the at least one predefined input based on the plurality of distances and a distance threshold.
13. The one or more non-transitory computer readable media of clauses 11 or 12, wherein the instructions, when executed by the one or more processors, further cause the one or more processors to perform the steps of generating the plurality of predefined inputs based on one or more database fields and one or more first predefined templates, and generating a plurality of predefined queries associated with the plurality of predefined inputs based on the one or more database fields and one or more second predefined templates.
14. The one or more non-transitory computer readable media of any of clauses 11-13, wherein the plurality of predefined inputs are further generated based on one or more user inputs associated with one or more responses that have been approved by one or more users.
15. The one or more non-transitory computer readable media of any of clauses 11-14, wherein the instructions, when executed by the one or more processors, further cause the one or more processors to perform the steps of displaying the query to a user, receiving, from the user, a corrected query that corrects the query, and storing the user input as a new predefined input and the corrected query as a new predefined query.
16. The one or more non-transitory computer readable media of any of clauses 11-15, wherein prompting the first trained machine learning model to generate the query comprises inputting, into the first trained machine learning model, a prompt that includes the user input and the at least one predefined query as at least one example.
17. The one or more non-transitory computer readable media of any of clauses 11-16, wherein the instructions, when executed by the one or more processors, further cause the one or more processors to perform the steps of executing the query using a database system, and in response to receiving an error from the database system, prompting a second trained machine learning model to generate a corrected query based on the user input, the query, and the error.
18. The one or more non-transitory computer readable media of any of clauses 11-17, wherein the instructions, when executed by the one or more processors, further cause the one or more processors to perform the steps of executing the corrected query using the database system, and in response to receiving another error from the database system, prompting the second trained machine learning model to generate another corrected query based on the user input, the corrected query, and the another error.
19. The one or more non-transitory computer readable media of any of clauses 11-18, wherein the user input is a question.

20. In some embodiments, a system comprises one or more memories storing instructions, and one or more processors coupled to the one or more memories that, when executing the instructions, perform the steps of receiving a user input, selecting, from a plurality of predefined inputs, at least one predefined input based on similarity to the user input, and prompting a trained machine learning model to generate a query based on the user input and at least one predefined query associated with the least one predefined input.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a query, the method comprising:
receiving a user input;
selecting, from a plurality of predefined inputs, at least one predefined input based on similarity to the user input; and
prompting a first trained machine learning model to generate a query based on the user input and at least one predefined query associated with the least one predefined input.

2. The computer-implemented method of claim 1, wherein selecting the at least one predefined input comprises:
generating an embedding of the user input;
computing a plurality of distances between the embedding of the user input and a plurality of embeddings of the plurality of predefined inputs; and
selecting the at least one predefined input based on the plurality of distances and a distance threshold.

3. The computer-implemented method of claim 1, further comprising:
generating the plurality of predefined inputs based on one or more database fields and one or more first predefined templates; and
generating a plurality of predefined queries associated with the plurality of predefined inputs based on the one or more database fields and one or more second predefined templates.

4. The computer-implemented method of claim 3, wherein the plurality of predefined inputs are further generated based on one or more user inputs.

5. The computer-implemented method of claim 1, further comprising:
displaying the query to a user;
receiving, from the user, a corrected query that corrects the query; and
storing the user input as a new predefined input and the corrected query as a new predefined query.

6. The computer-implemented method of claim 1, further comprising determining one or more key terms included in the user input, wherein the first trained machine learning model is further prompted to generate the query based on at least one of a database field or a formula associated with the one or more key terms.

7. The computer-implemented method of claim 1, wherein prompting the first trained machine learning model to generate the query comprises inputting, into the first trained machine learning model, a prompt that includes the user input and the at least one predefined query as at least one example.

8. The computer-implemented method of claim 1, further comprising:
executing the query using a database system; and
in response to receiving an error from the database system, prompting a second trained machine learning model to generate a corrected query based on the user input, the query, and the error.

9. The computer-implemented method of claim 8, wherein the first trained machine learning model is the second trained machine learning model.

10. The computer-implemented method of claim 1, wherein the first trained machine learning model comprises a large language model (LLM).

11. One or more non-transitory computer readable media including instructions that, when executed by one or more processors, cause the one or more processors to perform the steps of:
receiving a user input;
selecting, from a plurality of predefined inputs, at least one predefined input based on similarity to the user input; and
prompting a first trained machine learning model to generate a query based on the user input and at least one predefined query associated with the least one predefined input.

12. The one or more non-transitory computer readable media of claim 11, wherein selecting the at least one predefined input comprises:
generating an embedding of the user input using a second trained machine learning model;
computing a plurality of distances between the embedding of the user input and a plurality of embeddings of the plurality of predefined inputs; and
selecting the at least one predefined input based on the plurality of distances and a distance threshold.

13. The one or more non-transitory computer readable media of claim 11, wherein the instructions, when executed by the one or more processors, further cause the one or more processors to perform the steps of:
generating the plurality of predefined inputs based on one or more database fields and one or more first predefined templates; and
generating a plurality of predefined queries associated with the plurality of predefined inputs based on the one or more database fields and one or more second predefined templates.

14. The one or more non-transitory computer readable media of claim 13, wherein the plurality of predefined inputs are further generated based on one or more user inputs associated with one or more responses that have been approved by one or more users.

15. The one or more non-transitory computer readable media of claim 11, wherein the instructions, when executed by the one or more processors, further cause the one or more processors to perform the steps of:
displaying the query to a user;
receiving, from the user, a corrected query that corrects the query; and
storing the user input as a new predefined input and the corrected query as a new predefined query.

16. The one or more non-transitory computer readable media of claim 11, wherein prompting the first trained machine learning model to generate the query comprises inputting, into the first trained machine learning model, a prompt that includes the user input and the at least one predefined query as at least one example.

17. The one or more non-transitory computer readable media of claim 11, wherein the instructions, when executed by the one or more processors, further cause the one or more processors to perform the steps of:
executing the query using a database system; and
in response to receiving an error from the database system, prompting a second trained machine learning model to generate a corrected query based on the user input, the query, and the error.

18. The one or more non-transitory computer readable media of claim 11, wherein the instructions, when executed by the one or more processors, further cause the one or more processors to perform the steps of:
executing the corrected query using the database system; and
in response to receiving another error from the database system, prompting the second trained machine learning model to generate another corrected query based on the user input, the corrected query, and the another error.

19. The one or more non-transitory computer readable media of claim 11, wherein the user input is a question.

20. A system comprising:
one or more memories storing instructions; and
one or more processors coupled to the one or more memories that, when executing the instructions, perform the steps of:
receiving a user input,
selecting, from a plurality of predefined inputs, at least one predefined input based on similarity to the user input, and
prompting a trained machine learning model to generate a query based on the user input and at least one predefined query associated with the least one predefined input.
